(19) United States
(12) Patent Application Publication
(10) Pub. No.: US 2014/0333171 A1
(43) Pub. Date: Nov. 13, 2014

(54) ELECTRIC MOTOR

(71) Applicants: Elmar Lange, Gummersbach (DE); Philipp Matuschek, Aachen (DE)

(72) Inventors: Elmar Lange, Gummersbach (DE); Philipp Matuschek, Aachen (DE)

(73) Assignee: MATUSCHEK MESSTECHNIK GmbH, Alsdorf (DE)

(21) Appl. No.: 14/344,654

(22) PCT Filed: Sep. 3, 2012
(86) PCT No.: PCT/EP2012/067112

§ 371 Date: Jul. 2, 2014

(30) Foreign Application Priority Data
Sep. 21, 2011 (DE) 102011083128.2

(51) Int. Cl. H02K 3/18; H02K 15/095

(52) U.S. Cl. CPC H02K 3/18; H02K 15/095
USPC 310/208; 29/596

(57) ABSTRACT

An electric motor is provided having a rotor and a stator and in which the stator has poles which are surrounded by turns of a coil. Each turn is of planar design and the lower faces of subsequent turns rest on the upper faces of the respectively preceding turns. The system provides a simple, robust and efficient electric motor.

The invention relates to an electric motor comprising a rotor and a stator, which has poles which are surrounded by turns of a coil.

Conventionally, the poles of the stator and of the rotor extend in radial fashion. Usually, the poles of the stator are on the outside and surround the rotor poles. Designs are also known in which the stator poles are on the inside and the rotor poles are on the outside. In a further alternative design, the stator and the rotor have similar diameters. The poles of the stator and of the rotor extend in the axial direction towards one another in the vicinity of their circumference.

The object of the invention is to provide a simple, robust and efficient electric motor.

This object is achieved according to the invention by virtue of the fact that each turn has a planar formation, and the lower sides of following turns rest on the upper sides of the respectively preceding turns.

In other words, each coil which surrounds a stator pole consists of flat metal laminations or metal foils which rest on one another in helical fashion. The coil connections are formed by the start of the first turn and the end of the last turn, with the former being located at the radially inner end and the latter being located at the radially outer end of the coil. The turns do not cross over one another. This ensures that in each case only the voltage drop between two successive turns is present at the contact points of the turns. Turns with a relatively large voltage drop, for example the first turn and the last turn of the coil, cannot come into contact with one another. Owing to this limited voltage difference between two successive coil turns, reduced insulation of the surface of the turns is sufficient to avoid a current flow between the turns. Partial discharges, also referred to as PDI, can be avoided by such ordered winding of coils even in the case of a small amount of insulation for the individual turns.

In addition, the use of planar windings with turns stacked one on top of the other minimizes the risk of Eddy current losses within the turns. This increases the efficiency of the electric motor. Different turns numbers can be realized in a simple manner with stators of identical configuration by virtue of different thicknesses of the metal sheets from which the planar windings are manufactured. In this way, coils which are easy to manufacture can be realized for low system voltages at high currents.

Finally, a very high fill factor of the space available for the arrangement of the coils can be achieved with planar windings. As explained in more detail below, the proposed motor design enables virtually complete filling of the space surrounding the stator poles with the metal of the coil.

In particular, the invention is suitable for use with a switched reluctance motor which is intended primarily to be used as vehicle drive. The stator has a number of stator poles which are arranged equidistantly to one another. Each stator pole is surrounded by windings of a coil, which generate a magnetic field which exerts a torque on the adjacent pole of the rotor and sets the rotor in rotation. The rotor does not have any windings. The rotor poles are likewise arranged equidistantly. When a stator pole is aligned with a rotor pole, the reluctance (the magnetic resistance) is at its lowest. Rotating excitation of the stator poles results in a force being produced which brings the respectively most closely adjacent rotor pole into congruence with the excited stator pole in as optimum a fashion as possible. In other words, the reluctance (magnetic resistance) is minimized.

In order to form a coil with a plurality of turns, electrically conductive bridges between the individual turns can be produced by virtue of the fact that the first end of each following turn is electrically conductively connected to the second end of the respective preceding turn. The electrically conductive connection can be realized in a variety of ways. For example, the turns can be connected to one another by suitable coupling pieces or by soldering. Alternatively, the end sections of the turns can overlap one another slightly and can be welded by crimped seams. In the case of a slightly greater degree of overlap, projection welding with longitudinal projections for connecting the turns is also suitable.

Preferably, the electrically conductive connection is realized by virtue of the fact that the end face of the first end of each following turn is welded to the end face of the second end of the respective preceding turn. A welded joint between the metallic turns has a very high capacity for mechanical loading and good electrical conductivity. A homogeneous welded joint between the end faces ensures a minimal electrical resistance at the joint between the individual turns since electrical conductivity is ensured over the entire cross section of the welded end faces.

In practice, the turns can consist of aluminum or copper. Copper has better conductivity. Aluminum has a lower specific weight than copper.

The turns can in practice by sheathed by an insulating layer. Preferably, in the case of aluminum turns, an anodized aluminum layer is applied. By means of anodization, a layer which is insulating in respect of low voltages is produced on the surface of a turn. As explained at the outset, in each case only the differential voltage between two successive turns is present at those faces of the turns which rest on one another. It is preferable to design the power electronics for a low system voltage. Preferably, voltages in the range of from approximately 50 V to 120 V are present at the connections of each coil. The differential voltages of successive turns are consequently in the region of a few volts. The small amount of insulation as a result of the anodized aluminum layer is sufficient for ensuring the desired dielectric strength.

If a higher level of insulating effect is desired or, for example, copper turns are used, alternatively an enamel applied by immersion can be used to form the insulating layer on the surface of the turns.

In practice, the turns can form a coil which has at least one side face, which is inclined towards the adjacent side face of the stator pole surrounded by the turn. In a practical embodiment, the stator is on the outside and is connected in rotationally fixed fashion to the housing of the motor. In this case, the rotor moves on the inside and is connected to the axle of the motor. The stator consists of an outer, ring-shaped component, which has stator poles protruding inwards in the form of a star. A switched reluctance motor has a stator with a number of uniformly distributed poles. Each pole usually has a rectangular basic area. The side walls of the stator poles extend parallel to one another and in each case parallel to the substantially radially extending central line of each stator pole. The space enclosed between two stator poles therefore has a substantially trapezoidal cross section, wherein the shorter basic area is on the inside in the region of the opening of this space and the longer basic area is on the outside in the region of the ring-shaped stator. In other words, a space which is closed on the outer side and which is delimited by two side walls, which are inclined towards one another, is produced in each case between two stator poles. The inclination of the two side walls with respect to one another is greater the less stator poles are distributed over the entire circumference of the stator. In order to fill this space as completely as possible with the turns of a coil formed from a planar winding, at least one side face of the coil should be inclined towards the adjacent side face of the stator pole. In particular, in each case alternately a coil with inclined side faces and a coil with side faces which are parallel to the adjacent side faces of the stator pole surrounded by the coil can be arranged on the successive stator poles. In this case, first the coils with the inclined side faces are applied to the first, third, fifth etc. stator pole. The side faces of the coils are inclined in such a way that they in each case run parallel to the side faces of the following or preceding stator pole. Once the coils with inclined side faces have been arranged, coils with side faces which are parallel to the side faces of the respective stator poles can be applied. It is thus possible to fill the space between the stator poles completely with coil metal.

In the case of a hub motor, in which the stator is arranged within the rotor, the stator poles form projections which protrude outwards in the form of a star on the circumference of the stator. In this case, an inclination of the side faces of the coils likewise results in complete filling of the interspaces between the stator poles. However, the coils can have equally inclined side faces because, in this embodiment, the interspace between two stator poles opens out in the manner of a funnel. In this embodiment, all coils can have an identical shape, which reduces manufacturing costs.

In practice, that surface of the coil which bears against the stator can be matched to the contour of the stator in order that the coil bears against the stator as far as possible over the full area. As a result, thermal conduction between the coil and the stator is optimized since the heat is conducted over the entire surface. In conjunction with the excellent heat transfer within the coil as a result of the full-area contact between the turns, the dissipation of heat produced is optimized. In addition, that surface of the coil which points towards the rotor can also be matched to the contour of the rotor in order to further optimize the fill factor of the space surrounding the stator pole.

In addition, the invention relates to a method for producing an electric motor comprising a rotor and a stator, which has radially extending poles which are surrounded by turns of a coil. In order to solve the problem mentioned above, planar turns are arranged around each stator pole in such a way that the lower sides of following turns rest on the upper sides of the respective preceding turns. The first end of the following turns can in practice be connected, preferably welded at the end face, to the second end of the respective preceding turns. The turns are connected in practice by virtue of their ends being connected to form a coil and then sheathed by an insulating layer, preferably an anodized aluminum layer or an enamel layer. The turns of the coil are in practice sheathed with the insulating layer in the spread-apart state of said turns. For this, the turns can be spread by applying a tensile force to the first and last turn of the coil and immersed in an immersion bath for anodization or application of an enamel layer. Alternatively, the coil itself is produced with spread turns and is compressed after the application of the insulating layer.

As mentioned above, in practice the turns can form a coil which has at least one side face, which is inclined towards the adjacent side face of the stator pole surrounded by the turn. As a result, the coils can be arranged in such a way that they fill the space between the stator poles substantially completely.

In particular, in each case alternately, a coil with inclined side faces and a coil with side faces parallel to the adjacent side face of the stator pole surrounded by the coil are arranged on successive stator poles. First, the coils with inclined side faces are arranged, and then the coils whose side faces run parallel to the side faces of the stator pole surrounded by the respective coils are applied.

In order to produce the coil with inclined side faces, first identical planar turns of the coil can be connected to one another, with the result that a coil with outer and inner side faces which are parallel to one another is produced. Then, the side faces can be processed, for example, by means of milling in order to produce the inclination. This manufacturing process is very precise and cost efficient.

An embodiment of the invention will be described below with reference to the attached drawings.

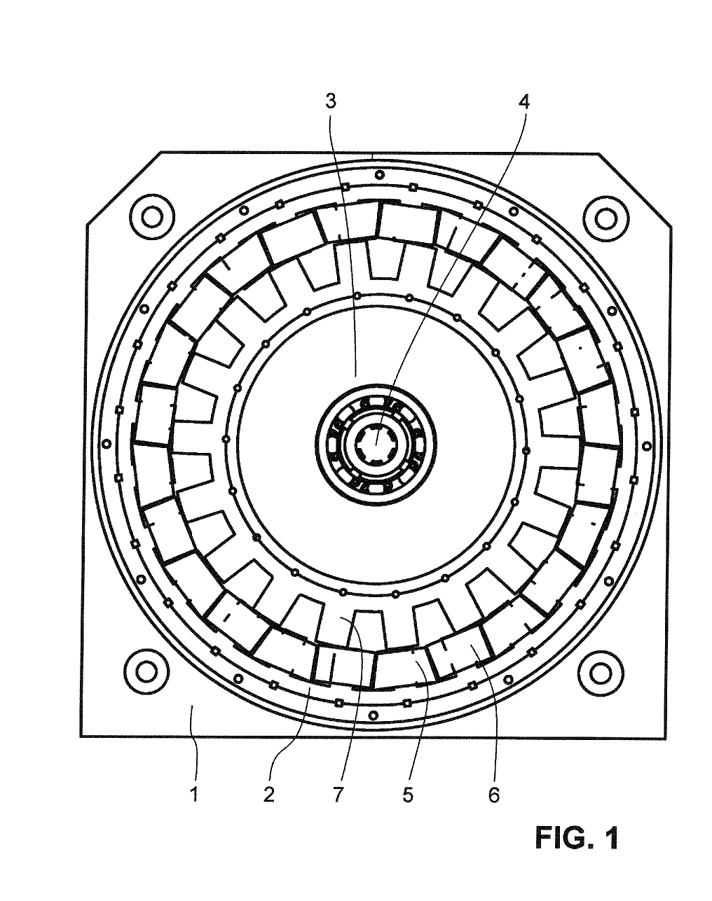

FIG. 1 shows a schematic front view of a housing of an electric motor according to the invention without cover for stator and rotor.

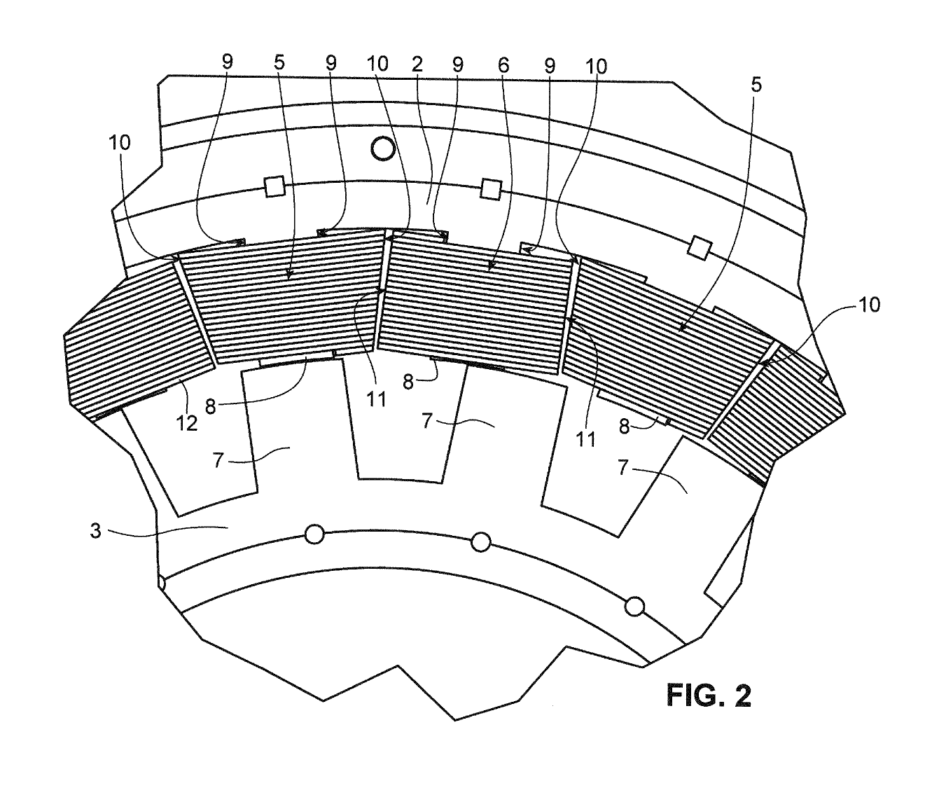

FIG. 2 shows an enlarged detail of the motor as shown in FIG. 1 with rotor pole and stator poles and windings which form coils surrounding the stator poles.

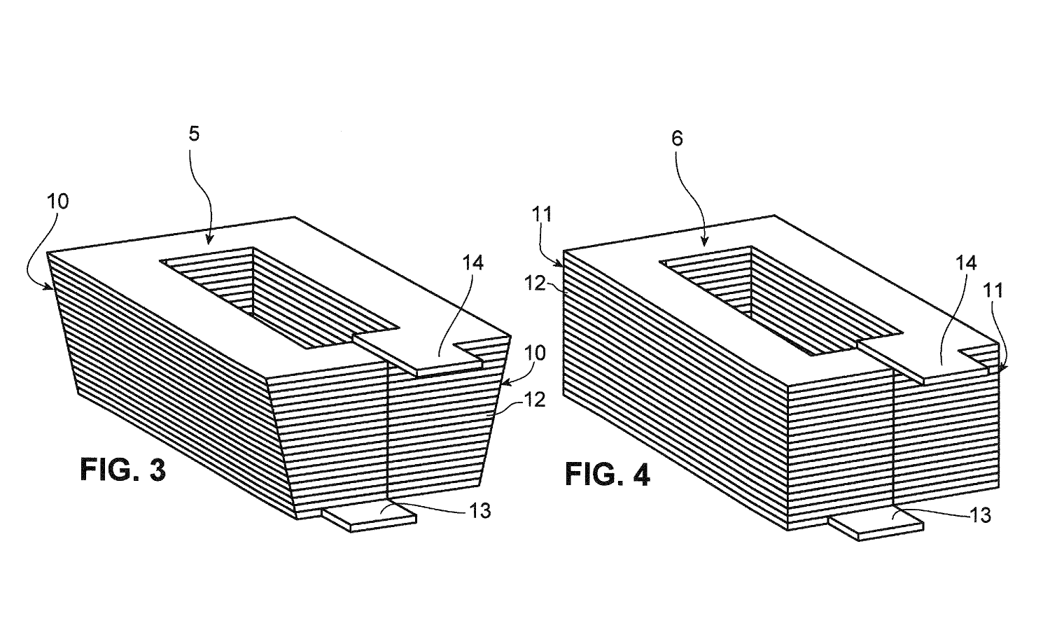

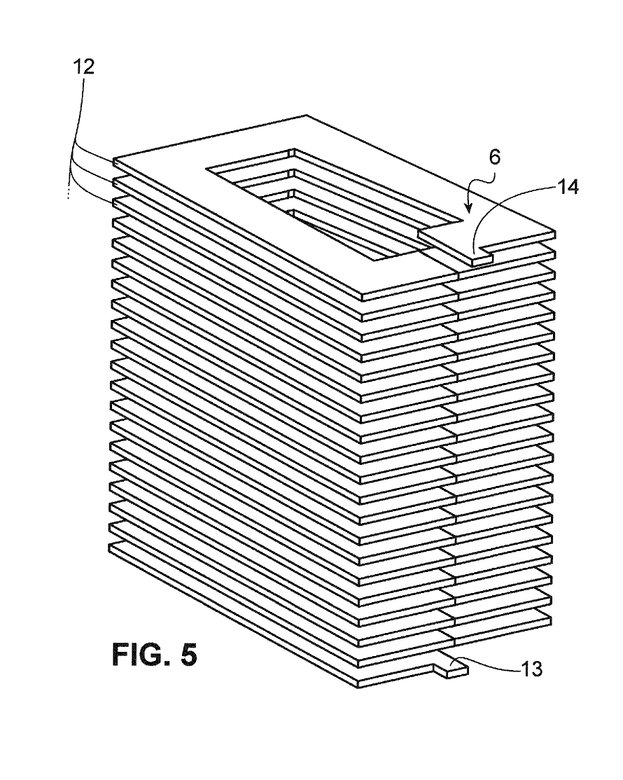

FIGS. 3 and 4 show two different embodiments of the coils.

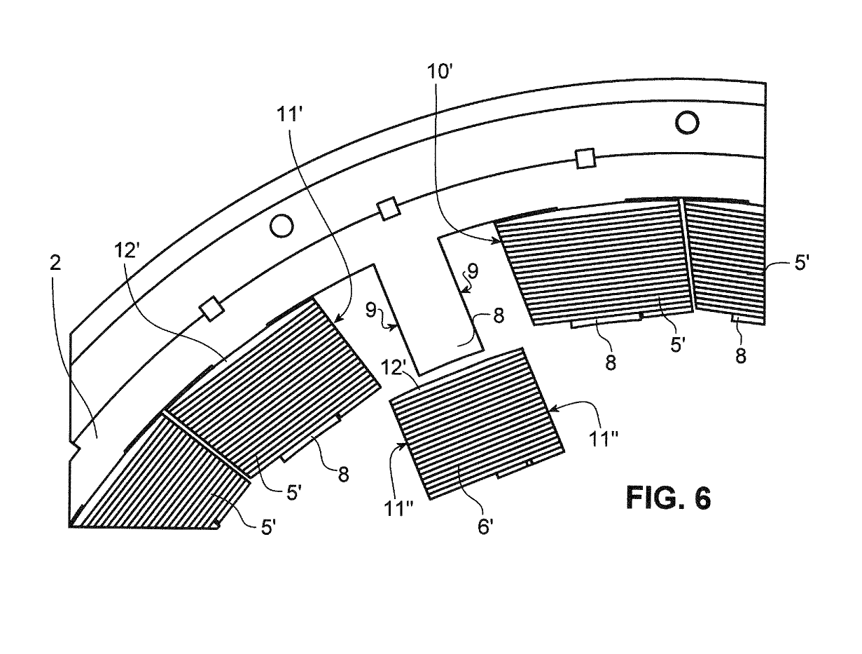

FIG. 5 shows the coil shown in FIG. 4 with turns separated from one another.

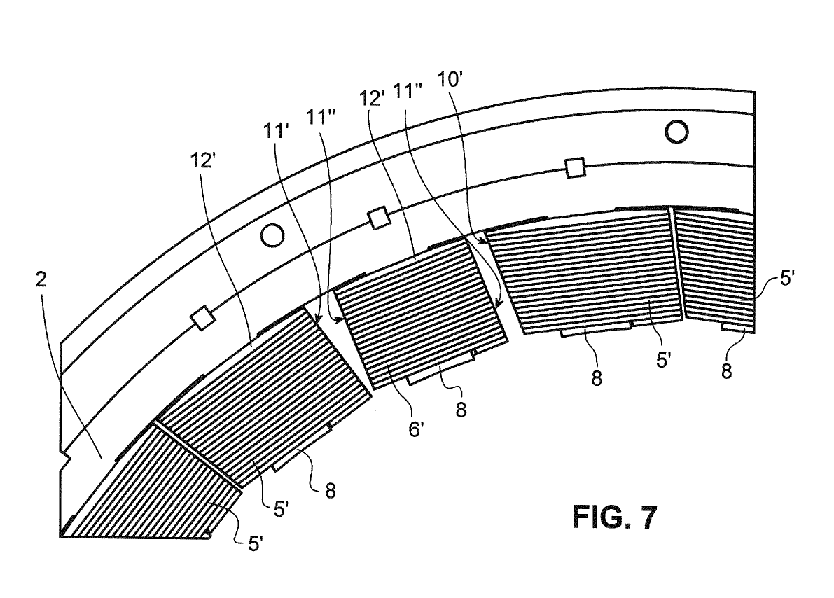

FIGS. 6 and 7 show two front views of a further embodiment of a stator with coils.

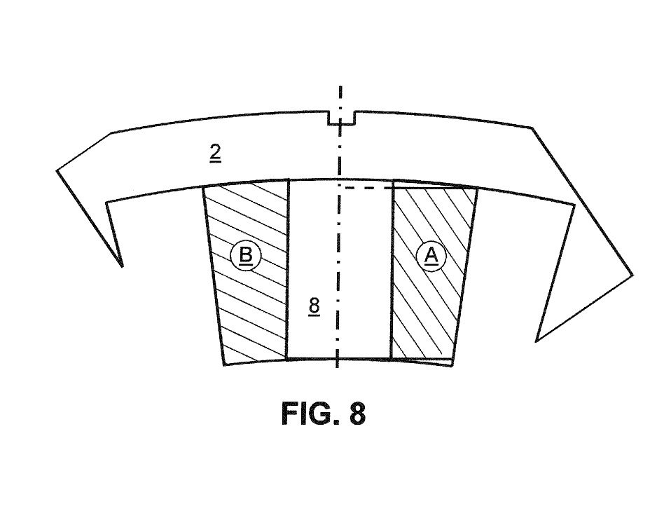

FIG. 8 shows a comparison of the filling of the interspace surrounding the stator pole with a coil with a flat surface and with a coil with a contour matched to the adjacent surfaces.

FIG. 1 shows the housing 1 of an electric motor. A stator 2 and a rotor 3 are arranged within the housing 1. The rotor 3 is connected to a motor shaft 4. The electric motor illustrated is a switched reluctance motor. The stator 2 has 24 poles, which are surrounded by coils 5, 6. The rotor 3 has 18 poles 7, which are not surrounded by coils. The coils 5, 6 around the stator poles 8 (see FIG. 2) generate a rotating field followed by the poles 7 of the rotor 3. It should be noted that combinations of rotors and stators with different pole numbers are also known, as well as combinations in which the rotor has more poles than the stator.

The various coils 5 and 6 are illustrated in enlarged form in FIG. 2. The alternately arranged coils 5 and 6 each surround one of the poles 8 of the stator 2. Each pole 8 of the stator has two side faces 9, which run parallel to one another and which also run parallel to the central plane of the stator pole 8. The coils 5 and 6 are formed differently.

In the case of the coils 5, the individual planar turns form side faces 10, which run at an angle to the side faces 9 of the stator pole 8 which is surrounded by the coil 5. The side faces 10 of each coil 5 largely run parallel to the side faces 9 of those stator poles 8 which are adjacent to the stator pole 8 surrounded by the coil 5. Thus, each side face 10 of a coil 5 with the opposite side faces 9 of the adjacent stator pole 8 forms an interspace with a rectangular contour and a constant width.

On the other hand, the coil 6 has side faces 11, which run parallel to the side faces 9 of the stator pole 8 surrounded by it. These side faces 11 also run parallel to the opposite side faces 10 of the two adjacent coils 5.

When equipping the stator poles 8 with coils, first every second stator pole 8 is provided with a coil 5 whose side faces 10 run inclined with respect to the most closely adjacent side faces 9 of the stator pole 8 surrounded by it and run substantially parallel to the most closely adjacent side face 9 of the adjacent stator pole 8. Then, the coils 6 with side faces 11 parallel to one another are pushed onto the poles 8 between two successive coils 5 with inclined side faces 10. These coils 6 have a rectangular cross section and can be inserted without any problems into the interspace between the side face 9 of the stator pole 8 surrounded by said coils and the opposite side face 11 of the adjacent coil 5. In this way, virtually complete filling of the spaces between the stator poles 8 is achieved.

The individual coils 5 and 6 are illustrated in a three-dimensional illustration in FIGS. 3 and 4. It can be seen that the width of the planar turns 12 which rest one on top of the other of the coil 5 (FIG. 3) increases from the bottom upwards, whereas the width of the planar turns 12 of the coil 6 remains constant. As a result, the outer side faces 11 of the coil 6 run parallel to one another and parallel to the inner side faces of the coil 6 (FIG. 4). The outer side faces 10 of the coils 5, on the other hand, run in inclined fashion with respect to the inner side faces thereof.

The planar turns 12 rest one on top of the other substantially over the full area. The start of the lowermost turn has the first coil connection 13. The end of the upper turn has in each case the second coil connection 14.

FIG. 5 shows the turns 12 of the coil 6 shown in FIG. 4 in an expanded state. For this, an axial tensile force is applied to the two outer turns 12 of the coil 6 in the direction of the coil axis. It can be seen that the end faces of the ends of two successive turns 12 are welded to one another.

In the separated state illustrated in FIG. 5, the coil 6 can be immersed in an anodization bath or enamel-coating bath, with the result that the surfaces of each individual turn 12 are coated with an anodized aluminum layer or a layer of enamel applied by immersion. This layer protects against a discharge between the individual turns 12 as a result of current flow through the surfaces thereof.

FIGS. 6 and 7 each show a detail of a stator 2 corresponding to the stator 2 in FIGS. 1 to 5, in this case provided with an alternative coil arrangement. The section illustrated shows just five of the 24 stator poles 8. In this case, adjacent poles 8 of the stator 2 are provided with identical coils 5′, which each have a side face 10′ only on one side, which side face is inclined towards the adjacent side face 9 of the stator pole 8 surrounded by the coil 5′. The second side face 11′ of each coil 5′ runs parallel to the adjacent side face 9 of the stator pole 8 surrounded by the coil 5′.

The inclined side face 10′ of the coil 5′ runs parallel to the side face 9 of the adjacent stator pole 8, with the result that an interspace with a rectangular cross section which is open on the radially inner side is produced between these two side faces 9 and 10′. Then, the section of further coil 5′, whose side face 11′ runs parallel to the adjacent side face 9 of the stator pole 8 surrounded by said coil 5′, is pushed into this interspace. FIG. 6 shows that this successive application of the coils 5′ is possible without any problems for all stator poles 8 except for the last stator pole.

The last stator pole 8, which is illustrated without a coil in FIG. 6, has an interspace with a rectangular cross section in the region of its right-hand side face 9. In the region of its left-hand side face 9, it has an interspace with a trapezoidal cross section, whose short basic area is in the region of the opening of the interspace. In this case, it is not possible to introduce a coil 5′ which has an inclined side face 10′. Instead, a coil 6′, whose side faces 11″ run parallel to the side faces 9 of the stator pole 8 surrounded by said coil, is provided for this stator pole 8. This coil 6′ is illustrated in FIG. 6 as being shifted radially inwards and at a distance from the last stator pole 8. FIG. 7 shows this coil 6′ in the state in which it is pushed onto the stator pole 8. It can be seen that the trapezoidal interspace on the left-hand side of the last stator pole 8 cannot be completely filled with the coil 6′. The width of the left-hand coil section corresponds to the smallest clear width of the interspace to the left of the last stator pole 8. The smallest clear width of this interspace is in the region of the radially inner opening of the interspace. The coil section on the right-hand side of the stator pole 8 has the same width as that on the left-hand side for reasons of symmetry.

Overall, the planar coil turns of this coil 6′ have a much smaller cross section than the planar turns of the other coils 5′. In order to achieve a conductivity corresponding to the other coils 5′, the coil 6′ can consist of a different material. If the other coils 5′ consist of aluminum, the coil 6′ can consist of copper. In the case of a stator 2 with 24 poles 8, one coil 5′ consisting of aluminum is therefore used for 23 poles 8, which coil 5′ fills the interspace between two successive stator poles 8 in optimum fashion and has clear weight advantages over other, more conductive materials. For the last pole, a copper coil 6′ is used which has better conductivity than aluminum and, owing to the reduced cross section of the turns, has comparable electrical properties to those of the coils 5′. The increased weight of the copper is negligible because copper is only used for one of 24 stator poles 8.

The coils 5′ and 6′ shown in FIGS. 6 and 7 also have another difference in respect of the coils shown in FIGS. 1 to 5. The turns 12′ of the coils 5′ and 6′, which turns adjoin the ring-shaped inner surface of the stator 8, have a surface profile which is matched to the contour of the stator 2. For this, that surface of these turns 12′ which rests against the stator can be reshaped in such a way that it runs in substantially complementary fashion with respect to the stator surface. The shaping can be performed, for example, with cutting, by grinding or milling, by forming or by casting the sheet metal which forms the turn 12′ close to the stator. That surface of the turn 12′ which is matched to the stator contour consequently rests on the surface of the stator 8 over the full area. As a result, the dissipation of heat out of the coil into the stator is improved. Since the individual turns 12 of the coils also bear against one another over the full area, the thermal conduction of heat generated in the coil in each case over the surfaces bearing against one another is very effective and much better than in a conventional coil consisting of wound wire.

In addition, that surface of the coil which faces the rotor can also be matched to the contour of the adjacent surface of the rotor. As a result, the fill factor of the interspace between two successive stator poles is further improved. FIG. 8 shows a comparison of the filling of the space adjoining the stator pole with a coil with flat surfaces and with a coil with surfaces matched to the adjacent stator face and the adjacent rotor face. The face A on the right-hand side has flat surfaces. In the case of the face B on the left-hand side, the surfaces are matched to the contour of the adjacent surfaces. The upper side of the coil follows the ring face of the stator. The downwardly pointing surface of the coil is matched to the cylindrical outer face of the rotor. This increases the overall area to be filled with coil metal by virtually 5%. As mentioned above, the coil can be ground or milled in shape. However, it is also possible for the coil turns to be brought to the desired shape by reshaping processes.

### LIST OF REFERENCE SYMBOLS

1 Housing

2 Stator

3 Rotor

4 Motor shaft

5, 5′ Coil

6, 6′ Coil

7 Rotor pole

8 Stator pole

9 Inclined side face of stator pole

10, 10′ Side face of coil

11, 11′, 11″ Side face of coil

12, 12′ Planar turn

13 First coil connection

14 Second coil connection

1-15. (canceled)

16. An electric motor, comprising:
a rotor; and
a stator having poles which are surrounded by turns of a coil, wherein each turn has a planar formation, and wherein lower sides of successive turns rest on the upper sides of respective preceding turns.

17. The electric motor as claimed in claim 16, wherein the turns are arranged resting one on top of the other in helical fashion.

18. The electric motor as claimed in claim 16, wherein a first end of each of the successive turns is electrically conductively connected to a second end of each of the respective preceding turns.

19. The electric motor as claimed in claim 18, wherein the first end of each of the successive turns is welded to the second end of each of the respective preceding turns.

20. The electric motor as claimed in claim 18, wherein the electrically conductive connection between the first end of each of the successive turns and the second end of each of the respective preceding turns has at least one of the following configurations:
(i) welding of end faces of the two ends;
(ii) welding of the two ends using a projection weld seam;
(iii) welding of the two ends using a crimped seam; or
(iv) welding an electrically conductive connecting piece to the two ends.

21. The electric motor as claimed in claim 16, wherein the turns include aluminum or copper.

22. The electric motor as claimed in claim 16, wherein the turns are sheathed by an insulating layer.

23. The electric motor as claimed in claim 22, wherein the insulating layer is an anodized aluminum layer or an enamel layer.

24. The electric motor as claimed in claim 16, wherein the turns form a particular coil having at least one side face which is inclined towards an adjacent side face of a particular stator pole surrounded by the particular coil.

25. The electric motor as claimed in claim 16, wherein either a surface of the coil which rests against the stator or a surface of the coil which faces the rotor is matched to a contour of an adjacent surface.

26. The electric motor as claimed in claim 25, herein the matching of the contour is performed by at least one of: grinding, milling or forming.

27. A method for producing an electric motor having a rotor and a stator, the stator having poles which are surrounded by turns of a coil, the turns having a planar formation, the method comprising:
arranging the turns around each of the poles such that a lower side of successive turns rest on an upper side of respective preceding turns.

28. The method as claimed in claim 27, wherein a first end of each of the successive turns is connected to a second end of each of the respective preceding turns.

29. The method as claimed in claim 28, wherein the first end of each of the successive turns is welded at an end face to the second end of each of the respective preceding turns.

30. The method as claimed in claim 28, wherein the turns are connected by ends of the turns being connected to form the coil, and are then sheathed by an insulating layer.

31. The method as claimed in claim 30, wherein the insulating layer is an anodized aluminum layer or an enamel layer.

32. The method as claimed in claim 30, wherein the turns of the coil are sheathed with the insulating layer in a spread-open state of the turns.

33. The method as claimed in claim 27, wherein the turns form a particular coil having at least one side face which is inclined towards an adjacent side face of the stator pole surrounded by the particular coil.

34. The method as claimed in claim 27, wherein at least a first coil with inclined side faces and at least a second coil with side faces parallel to an adjacent side face of a stator pole surrounded by the second coil are arranged on a successive stator pole.

35. The method as claimed in claim 34, wherein, first, the turns of the first coil are connected to one another, and then the inclined side faces are produced.
